(19) United States
(12) Patent Application Publication
(10) Pub. No.: US 2009/0146885 A1
(43) Pub. Date: Jun. 11, 2009

(54) Multi-frequency antenna

(75) Inventors: Wen-Fong Su, Tu-cheng (TW); Lung-Sheng Tai, Tu-cheng (TW); Hsieh-Sheng Tseng, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/316,155

(22) Filed: Dec. 10, 2008

(30) Foreign Application Priority Data
Dec. 10, 2007 (TW) 96146961

(51) Int. Cl. H01Q 1/38

(52) U.S. Cl. 343/700 MS

(57) ABSTRACT

A multi-frequency antenna (100) comprises a grounding patch (40), a radiating patch (20), a connecting element (300). The grounding patch (40) lying in a first plane has opposite first and second sides. The radiating patch (20) lying in a second plane is spaced apart from the grounding patch. The connecting element (300) comprises a matched impedance element (30) lying in a third plane. The first plane is parallel to the third plane. The matched impedance element has “n” shape structure and comprises a first branch, a second branch paralleling to the first branch, and a third branch connecting the first branch and the second branch.

### BACKGROUND OF THE INVENTION

1. Field of the Invention

The present invention relates to an antenna, and more particularly to an multi-frequency antenna having a grounding patch lying in a first plane; a radiating patch lying in a second plane spaced apart from the grounding patch; and a connecting element comprising an matched impedance element lying in a third plane benefiting a favorable effect of matched impedance.

2. Description of Prior Art

Wireless communication devices, such as cellular phones, notebook computers, electronic appliances, and the like, are normally equipped with an antenna that serves as a medium for transmission and reception of electromagnetic signals, such as date, audio, image, and so on.

PIFA (Planar Inverted-F Antenna) is a kind of mini antenna usually used in the portable electronic devices. PIFA has featured a compact structure, light weighted, excellent impedance match, desirable horizontal polarization and vertical polarization, and is easy to achieve multi-frequency is easy to work under different frequencies). As a result, more and more PIFAs are used built in the portable electronic devices.

Taiwanese Utility Patent No. 563274 discloses a multi-frequency inverted-F antenna that comprises: a conductive radiating element extending in a longitudinal direction and having opposite first and second ends lying in the longitudinal direction; a conductive grounding element spaced apart from the radiating element in a transverse direction relative to the longitudinal direction; a conductive interconnecting element extending between the radiating and grounding elements and including first, second, and third parts, the first part being electrically connected to the radiating element at a feeding point between the first and second ends of the radiating element, the second part being offset from the first part in the longitudinal direction and being electrically connected to the grounding element, the third part electrically interconnecting the first and second parts; and a feeding line electrically connected to the conductor interconnecting element.

However, modulation of matched impedance of multi-frequency) depends mostly on the length of the side of the grounding element. In some conditions, the length of the grounding element is so short that can not satisfactorily create a required capacitance with the interconnecting element.

### SUMMARY OF THE INVENTION

An object of the present invention is to provide a multi-frequency antenna which has better effect of matched impedance.

To achieve the aforementioned object, the present invention provides a multi-frequency antenna comprises: a grounding patch lying in a first plane having opposite first and second sides; a radiating patch lying in a second plane spaced apart from the grounding patch; a connecting element comprising an matched impedance element lying in a third plane. The first plane is parallel to the third plane. The matched impedance element has n-shape structure and comprises a first branch, a second branch paralleling to the first branch, and a third branch connecting the first branch and the second branch.

Additional novel features and advantages of the present invention will become apparent by reference to the following detailed description when taken in conjunction with the accompanying drawings.

### BRIEF DESCRIPTION OF THE DRAWINGS

FIG. 1 is a perspective view of a multi-frequency antenna in accordance with a preferred embodiment of the present invention;

FIG. 2 is a view similar to FIG. 1, but from a different aspect;

FIG. 3 is a test chart recording for the second antenna of the multi-frequency antenna in accordance with a preferred embodiment of the present invention, showing Voltage Standing Wave Ratio (VSWR) of frequency band.

### DETAILED DESCRIPTION OF THE INVENTION

Reference will now be made in detail to the preferred embodiment of the present invention.

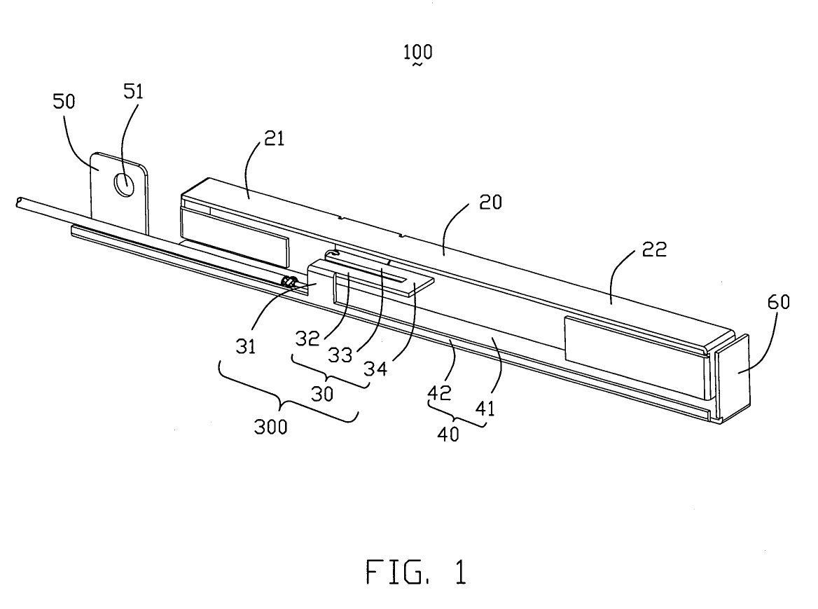

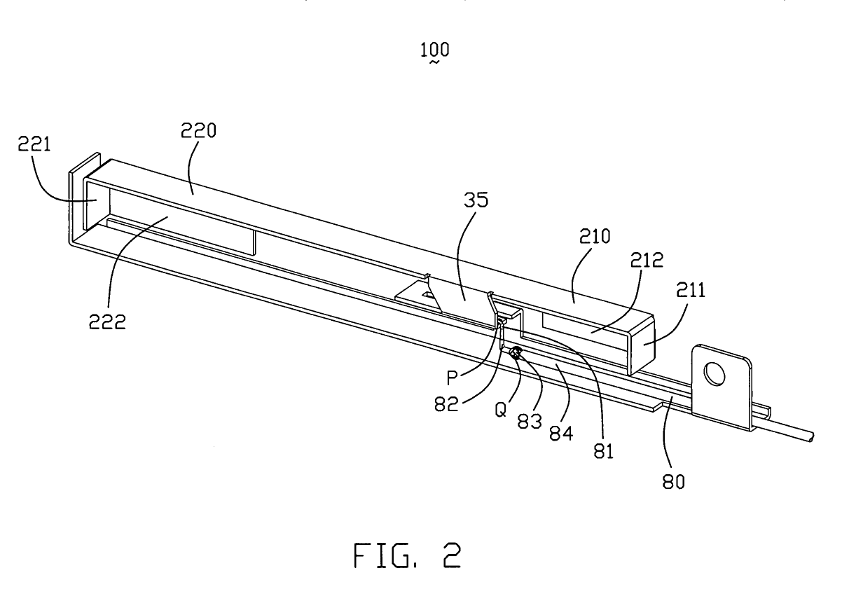

Referring to FIGS. 1 and 2, a multi-frequency antenna 100 in accordance with a first embodiment of the present invention comprises a grounding patch 40, a radiating patch 20 spaced apart from the grounding patch 40, a feeding line 80, and a connecting element 300 connecting the radiating patch 20 and the grounding patch 40.

The grounding patch 40 comprises a horizontal grounding element 41 lying in a first plane and a vertical grounding element 42 extending vertically and upwardly from a side of the horizontal grounding element 41. An end of the horizontal grounding element 41 has a gap defining a installing element 50 extending vertically and upwardly from a side of the gap. The installing element 50 has a installing hole 51. A coupling element 60 extends vertically and upwardly from another end of the horizontal grounding element 41.

The radiating patch 20 comprises a first radiating element 21 operating in 1900 MHz frequency band and a second radiating element 22 operating in 900 MHz frequency band. The first radiating element 21 comprises a first horizontal radiating element 210 paralleling to the first horizontal grounding element 41, a first vertical radiating element 211 extending vertically and downwardly from an end of the first horizontal radiating element 210, and a first radiating branch 212 extending from a side of the first vertical radiating element 211. The first horizontal radiating element 210, the first vertical radiating element 211, and the first radiating branch 212 are parallel to each other. The second radiating element 22 comprises a second horizontal radiating element 220 paralleling to the first horizontal grounding element 41, a second vertical radiating element 221 extending vertically and downwardly from an end of the second horizontal radiating element 220, and a second radiating branch 222 extending from a side of the second vertical radiating element 221. The second horizontal radiating element 220, the second vertical radiating element 221, and the second radiating branch 222 are parallel to each other. The first horizontal radiating element 210 and the second horizontal radiating element 220 connects to each other and lie in a longitudinal direction. The first horizontal radiating element 210 and the second horizontal radiating element 220 are defined in a second plane.

The connecting element 300 comprises a conductor interconnecting patch 31 extending from the middle portion of the vertical grounding element 42 and a matched impedance element 30 extending from the conductor interconnecting patch 31. The matched impedance element 30 having “n” shape is defined in a third plane paralleling to the second plane. The first plane, the second plane, and the third plane are parallel to each other. The matched impedance element 30 comprises a first branch 32 extending from the conductor interconnecting patch 31, a second branch 33 paralleling to the first branch 32, and a third branch 34 connecting the first branch 32 and the second branch 33. The first branch 32, the second branch 33, and the third branch 34 form a slot capable to modulate the matched impedance of the multi-frequency antenna 100. The length of the matched impedance element 30 is capable modulated along with requirement and has no influence by the length of the side of the grounding patch 40. Further more, the matched impedance element 30 is parallel to the horizontal grounding element 41, so, the multi-frequency antenna 100 has lower profile being beneficial to miniaturization development of the notebook computer.

A conductor element 35 connects the radiating patch 20 and the second branch 33 of the matched impedance element 30. The conductor element 35 has a wider width than the first branch 32, the second branch 33, and the third branch 34. The conductor element 35 and the conductor interconnecting patch 31 are vertical to the matched impedance element 30. The conductor element 35 and the conductor interconnecting patch 31 locate at two opposite sides of the matched impedance element 30.

The feeding line comprises inner conductor 81, an inner insulating layer 82, an outer conductor 83, and an outer insulating layer 84. The inner conductor electrically connects to a feeding point P. The feeding point P is a point of a joint of the conductor element 35 and the second branch 33 of the matched impedance element 30. The outer conductor 83 electrically connects to a grounding point Q of the grounding patch 40.

The coupling element 60 is parallel to the second vertical radiating element 221 of the second radiating element 22. The length of the second radiating element 22 is reduced because of the coupling element 60 is coupling with the second radiating element 22.

Of course, the first radiating element 21 and the second radiating element 22 is capable only having horizontal radiating element in other embodiment of the present invention.

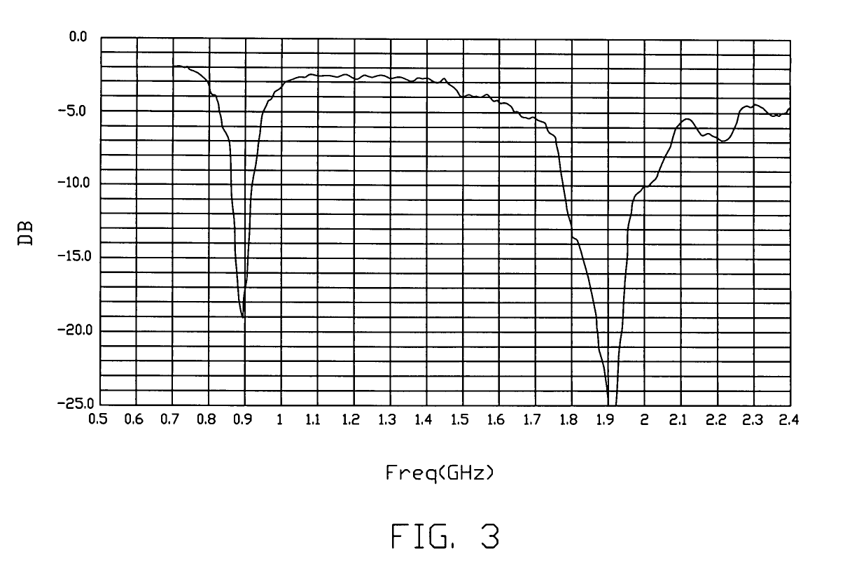

FIG. 3 is a test chart of Voltage Standing Wave Ratio of the multi-frequency antenna 100. Referring to FIG. 3, operating frequency band of the multi-frequency antenna 100 are 830 MHz-960 MHz and 1710 MHz-2170 MHz. Above-mentioned operating frequency band has covered all of the frequency bands of the WWAN.

What is claimed is:

1. A multi-frequency antenna, comprising:
a grounding patch lying in a first plane having opposite first and second sides;
a radiating patch lying in a second plane spaced apart from the grounding patch;
a connecting element comprises an matched impedance element lying in a third plane; wherein
the first plane parallels to the third plane; the matched impedance element has “n” shape structure and comprises a first branch, a second branch paralleling to the first branch, and a third branch connecting the first branch and the second branch.

2. The multi-frequency antenna as claimed in claim 1, wherein said second plane are parallel to the first plane and the second plane.

3. The multi-frequency antenna as claimed in claim 1, wherein said connecting element comprises a conductor interconnecting patch extending vertically from the grounding patch and connecting the grounding patch and the matched impedance element.

4. The multi-frequency antenna as claimed in claim 3, wherein said multi-frequency antenna comprises a conductor element extending from the radiating patch and connecting the radiating patch and the matched impedance element.

5. The multi-frequency antenna as claimed in claim 1, wherein the radiating patch comprises a first radiating element and a second radiating element; the first radiating element comprises a first horizontal radiating element paralleling to the first plane; the second radiating element comprises a second horizontal radiating element paralleling to the first plane.

6. The multi-frequency antenna as claimed in claim 5, wherein said first radiating element comprises a first vertical radiating element extending vertically and downwardly from an end of the first horizontal radiating element and a first radiating branch extending from a side of the first vertical radiating element; the first horizontal radiating element, the first vertical radiating element, and the first radiating branch are vertical to each other.

7. The multi-frequency antenna as claimed in claim 5, wherein said second radiating element comprises a second vertical radiating element extending vertically and downwardly from an end of the second horizontal radiating element and a second radiating branch extending from a side of the second vertical radiating element; the second horizontal radiating element, the second vertical radiating element, and the second radiating branch are vertical to each other.

8. The multi-frequency antenna as claimed in claim 4, wherein said conductor interconnecting patch and the conductor element are vertical to the matched impedance element.

9. The multi-frequency antenna as claimed in claim 1, wherein said grounding patch has an end defining an installing element having a installing hole.

10. The multi-frequency antenna as claimed in claim 9, wherein said grounding patch has a coupling element extending an end of the grounding patch opposite to the installing element.

11. The multi-frequency antenna as claimed in claim 9, wherein said multi-frequency antenna comprises a feeding line comprising an inner conductor electrically connecting to a feeding point and outer conductor electrically connecting to the grounding patch.

12. A multi-frequency antenna comprising:
a ground patch essentially extending along a longitudinal direction and lying in
a first plane;
a radiating patch essentially extending along said longitudinal direction and lying in a second plane;
a connecting element comprising a matched impedance element lying in a third plane under condition that the third plane is located between, in a vertical direction perpendicular to said longitudinal direction, the first plane and the second plate with a parallel relationship; wherein
said connecting element is unitarily connected between the grounding patch and the radiating patch with a Z-like configuration in a side view along said longitudinal direction.

13. The multi-frequency antenna as claimed in claim 12, wherein two opposite ends of the connecting element in said vertical direction are respectively connected two different sides of a whole antenna structure in said longitudinal direction.

14. The multi-frequency antenna as claimed in claim 12, wherein said matched impedance element defines a slot extending in said longitudinal direction with one open end thereof.

15. The multi-frequency antenna as claimed in claim 12, wherein an upper end of the connecting element is connected to one longitudinal edge of the grounding patch while a bottom end of the connecting element is connected to another longitudinal edge of the radiating patch opposite to said one longitudinal direction in a diagonal direction.

16. A multi-frequency antenna comprising:
a ground patch essentially extending along a longitudinal direction and lying in a first plane;
a radiating patch essentially extending along said longitudinal direction and lying in a second plane parallel to the first plane;
a connecting element comprising a matched impedance element lying in a third plane under condition that the third plane is located between, in a vertical direction perpendicular to said longitudinal direction, the first plane and the second plate; wherein
said connecting element is unitarily connected between the grounding patch and the radiating patch with thereof opposite upper and lower ends in a diagonal direction.

17. The multi-frequency antenna as claimed in claim 16, wherein said matched impedance element lies in a third plane which is parallel to both said first plane and said second plane.
